(19) United States
(12) Patent Application Publication
(10) Pub. No.: US 2025/0329491 A1
(43) Pub. Date: Oct. 23, 2025

(54) VRM USING FOUR-PHASE ANTI-COUPLING INDUCTOR TECHNOLOGY

(71) Applicant: SHANGHAI METAPWR ELECTRONICS CO., LTD, Shanghai (CN)

(72) Inventors: Mingzhun ZHANG, Shanghai (CN); Xiaoni Xin, Shanghai (CN); Yahong Xiong, Shanghai (CN)

(73) Assignee: SHANGHAI METAPWR ELECTRONICS CO., LTD, Shanghai (CN)

(21) Appl. No.: 19/186,648

(22) Filed: Apr. 23, 2025

(30) Foreign Application Priority Data
Apr. 23, 2024 (CN) 202410489862.9
Feb. 11, 2025 (CN) 202510151397.2

(51) Int. Cl. H01F 27/29; H01F 27/24; H01F 41/061

(52) U.S. Cl. CPC H01F 27/292; H01F 27/24; H01F 41/061

(57) ABSTRACT

The application relates to a VRM (four-phase anti-coupling VRM or VRM) adopting a four-phase anti-coupling inductor technology. By adopting a four-phase anti-coupling inductor technology, the VRM not only has rapid transient performance, but also has high conversion efficiency.

### CROSS-REFERENCE TO RELATED APPLICATION

This application claims the priority benefit of China application serial no. CN 202410489862.9, filed on Apr. 23, 2024 and China application serial no. 202510151397.2, filed on Feb. 11, 2025. The entirety of each of the above-mentioned patent applications is hereby incorporated by reference herein and made a part of this specification.

### BACKGROUND

### Description of Related Art

In recent years, with the development of technologies such as data centers, artificial intelligence and supercomputers, more and more A SIC chips with powerful functions are applied, such as a CPU, a GPU, a machine learning accelerator chip, a network switch chip and the like, which consume a large amount of current, for example, reach thousands of amperes, and the working current of the A SIC chip changes rapidly. A voltage regulator module (VRM) consisting of a multi-phase buck circuit is conventionally used to supply such a load. In order to meet the rapid change of the working current of the A SIC chip, the VRM increases the number of phases of the multi-phase buck circuit and increases the capacitance of the output decoupling capacitor, thereby increasing the transient response performance of the output voltage of the VRM. However, due to the larger output impedance of the VRM and the output decoupling capacitor space limitation, the traditional VRM is not good in the aspect of output voltage transient response. Other techniques for improving the transient response performance of a conventional VRM output voltage, such as increasing the switching frequency and/or reducing the output inductance value, can improve the output voltage transient response performance, but at the cost of efficiency reduction.

The anti-coupling inductor technology has relatively low leakage inductance, and therefore has relatively high transient response performance; meanwhile, the anti-coupling inductor has relatively high steady-state equivalent inductance, so that the efficiency is improved; and the anti-coupling inductor technology can meet the requirement of transient performance and improve the efficiency, so that the anti-coupling inductor technology is a hot spot designed by the VRM.

According to the application, a series of four-phase anti-coupling inductor structures and implementation methods are described by taking a four-phase anti-coupling inductor and a VRM structure and an implementation method adopting a four-phase anti-coupling inductor as an example to solve the above-mentioned challenges faced by the VRM.

### SUMMARY

In view of the above, one of the objectives of the application is to provide a integrated inductor comprises an inductor and a plurality of electrical connectors; the inductor comprises a magnetic core and a winding, and the winding comprises a first winding, a second winding, a third winding and a fourth winding; the integrated inductor is provided with four side surfaces, namely a first side surface, a second side surface, a third side surface and a fourth side surface, wherein the first side surface is opposite to the third side surface, and the second side surface is opposite to the fourth side surface;
the magnetic core comprises a first magnetic substrate, a second magnetic substrate and a magnetic column, the magnetic column is arranged between the first magnetic substrate and the second magnetic substrate, and the magnetic column comprises a first magnetic column, a second magnetic column, a third magnetic column and a fourth magnetic column;
each of the first to fourth windings is provided with a first pin and a second pin, the first pin of each of the first to fourth windings is arranged on a top surface of the integrated inductor, and the second pin of each of the first to fourth windings is arranged on a bottom surface of the integrated inductor; the first pins of the first to fourth windings are respectively arranged on the four side surfaces, and the four second pins are arranged on the four side surfaces respectively; the first pin and the second pin of each of the first to fourth windings are respectively arranged on two adjacent side surfaces;
the position of the first winding corresponds to the position of the first magnetic column, the position of the second winding corresponds to the position of the second magnetic column, the position of the third winding corresponds to the position of the third magnetic column, and the position of the fourth winding corresponds to the position of the fourth magnetic column; and each of the first to fourth windings is wound around the corresponding one of the first to fourth magnetic columns;
the plurality of electrical connectors are arranged adjacent to the four side surfaces of the integrated inductor respectively, each electrical connector comprises a top surface bonding pad and a bottom surface bonding pad, the top surface bonding pad of each electrical connector is arranged on the top surface of the integrated inductor, and the bottom surface bonding pad of each electrical connector is arranged on the bottom surface of the integrated inductor;
the integrated inductor is fixed and electrically connected with a top plate assembly through one of the first pins and one of the top surface bonding pads, and the integrated inductor is fixed and electrically connected with a bottom plate assembly through one of the second pins and one the bottom surface bonding pads.

Preferably, wherein the plurality of electrical connectors comprise four sets of electrical connector assemblies and a frame; the four sets of electrical connector assemblies are arranged in the frame; the four sets of electrical connector assemblies are arranged adjacent to the first side surface, the second side surface, the third side surface and the fourth side surface respectively; and the top surface bonding pads and the bottom surface bonding pads of the plurality of electrical connectors are arranged on a top surface and a bottom surface of the frame respectively.

Preferably, wherein each set of electrical connector combinations further comprise signal electrical connector; and an input positive electrical connector, a GND electric connector and the signal electrical connector in each set of electrical connector combinations are sequentially arranged in a same direction.

Preferably, wherein each set of electrical connector combinations comprises an input positive electrical connector and a GND electrical connector; and the input positive electrical connector and the GND electrical connector in each set of electrical connector combinations are sequentially arranged in a same direction.

Preferably, wherein each of the first to fourth windings comprises a first end and a second end; the first end is a part of the each of the first to fourth windings which is bent towards a top surface of the magnetic core; the second end is a part of the each of the first to fourth windings which is bent towards a bottom surface of the magnetic core; and the first end and the second end in a same winding are arranged adjacent to the two adjacent side surfaces respectively.

Preferably, wherein the first magnetic substrate comprises four notches, each notch is arranged adjacent to one corresponding side surface, and the notch is used for containing the first end of the each of the first to fourth windings; the second magnetic substrate comprises four notches, each notch is arranged adjacent to one corresponding side surface, and the four notches are used for containing the second end of the each of the first to fourth windings.

Preferably, wherein the magnetic core is made of a magnetic material, and the winding and the magnetic material are integrally pressed to form the inductor.

Preferably, wherein an electrical connector assembly is bonded to a side surface of the inductor.

Preferably, wherein the magnetic core is made of a magnetic material, and an electrical connector combination, the winding and the magnetic material are integrally pressed to form the inductor.

Preferably, wherein the electrical connector combination comprises an input positive electrical connector and a GND electrical connector; the integrated inductor further comprises a signal electrical connector, and the signal electrical connector is provided within two vertical plates; and the two vertical plates are arranged adjacent to the two opposite side surfaces respectively.

Preferably, wherein air gaps or fifth magnetic columns are further arranged in the middle of the first to fourth magnetic columns.

Preferably, wherein the frame comprises an inductor groove, the inductor groove is formed in the middle of the top surface of the frame, and the inductor groove is used for arranging the inductor; and a connecting part is arranged on the bottom surface of the frame.

Preferably,, wherein a winding bonding pad is arranged on a bottom surface of the inductor groove; the winding bonding pad is fixed to the second pin and is electrically connected with the second pin.

Preferably, wherein the winding bonding pad is electrically connected with the corresponding connecting part through an internal wiring of the frame; and the plurality of electrical connectors are electrically connected with the corresponding connecting parts through the internal wiring of the frame.

Preferably, wherein the frame is a printed circuit board, and the plurality of electrical connectors and the first to fourth windings are arranged in the printed circuit board; a magnetic core groove is formed in a top surface and a bottom surface of the printed circuit board through a depth-controlled milling process; the magnetic core groove is used for accommodating a magnetic substrate; and the first magnetic substrate and the second magnetic substrate are respectively buckled with the winding from the top surface and the bottom surface of the printed circuit board.

Preferably, wherein the first to fourth windings are realized through internal wiring of the printed circuit board, or are realized through embedded copper blocks in the printed circuit board.

Preferably, wherein the plurality of electrical connectors can be realized by combining a drilling or digging groove with an electroplating process, or the plurality of electrical connectors are realized by embedded copper blocks in the printed circuit board.

Preferably, wherein the plurality of electrical connectors are input positive electrical connectors and GND electrical connectors; the integrated inductor further comprises a signal electrical connector; and the signal electrical connector is realized through a through hole.

Preferably, wherein each of the first to fourth windings is in “H” shape; a first end of each of the first to fourth windings extends upwards and downwards, and a second end of each of the first to fourth windings extends upwards and downwards.

Preferably, wherein the inductor is formed by following manufacturing steps:
step 1, preparing a metal plate, the thickness of the metal plate being far less than the length and width of the metal plate;
step 2, stamping the metal plate to form a first winding plate, wherein the first winding plate comprises four windings and four connecting tabs; the four connecting tabs are respectively arranged between two adjacent windings; the two adjacent windings are connected through corresponding connecting tab; then the first winding plate is subjected to electroplating treatment;
step 3, forming a fixing body on the first winding plate through plastic packaging materials or plastic injection; the fixing body is arranged between the four connecting tabs, and the four connecting tabs are exposed out of the fixing body;
step 4, bending a first end of a winding upwards, and bending a second end of the same winding downwards;
step 5, removing the four connecting tabs to form a winding assembly, wherein the removing mode can be laser sintering, scribing machine or machining;
the winding assembly and the magnetic core formed in the step 5 are assembled and fixed to form the inductor.

Preferably, wherein the inductor is formed by following manufacturing steps:
step 1, directly forming metal powder into an “H”-shaped winding assembly through processes such as high-pressure forging, die-casting, or metal injection molding (MIM); the winding assembly comprises four windings and four connecting tabs; the four connecting tabs are respectively arranged between two adjacent windings; the two adjacent windings are connected through corresponding connecting tabs;
step 2, assembling and fixing the winding assembly obtained in step 1 and a part of the magnetic core;
step 3, removing the four connecting tabs to form a semi-finished product, wherein the removing mode can be laser sintering, scribing machine or machining;
step 4, assembling and fixing the semi-finished product formed in the step 3 and other parts of the magnetic core to form the inductor.

Preferably, a four-phase anti-coupling VRM comprises a top plate assembly and the integrated inductor, wherein each of the first to fourth windings is fixed and electrically connected with the top plate assembly through respective first pins; and the plurality of electrical connectors are fixed and electrically connected with the top plate assembly through respective top surface bonding pads.

Preferably, wherein a connecting part is directly fixed and electrically connected with an external system board.

Preferably, the four-phase anti-coupling VRM further comprises a bottom plate assembly, and the second pin and a bottom bonding pad are electrically connected to an outside through the bottom plate assembly.

Preferably, wherein the top plate assembly comprises an IPM unit, the IPM unit comprises a first IPM unit, a second IPM unit, a third IPM unit and a fourth IPM unit, and each IPM unit comprises a switch node; the position of the first winding corresponds to the position of the first IPM unit, the position of the second winding corresponds to the position of the second IPM unit, the position of the third winding corresponds to the position of the third IPM unit, and the position of the fourth winding corresponds to the position of the fourth IPM unit; and the first pin of each of the first to fourth windings is vertically and partially overlapped and electrically connected with the switch node of the corresponding one of the first to fourth IPM units.

Preferably, the four-phase anti-coupling VRM further comprises four columns of input capacitors, wherein each column of input capacitors is arranged between two adjacent IPM units respectively; the IPM unit further comprises a signal pin column, a VIN pin and a GND pin; each column of input capacitors is arranged adjacent to the VIN pin and the GND pin of one of the first to fourth IPM unit; and each column of input capacitors is perpendicular to the signal pin column of the corresponding one of the first to fourth IPM units.

Preferably, the four-phase anti-coupling VRM further comprises four columns of passive elements, wherein each column of the passive elements is respectively arranged between one side surface of the top plate assembly and a signal pin column corresponding to the IPM unit.

Preferably, wherein the plurality of electrical connectors comprise an input positive electrical connector and a GND electrical connector; a top surface pad of the input positive electrical connector vertically and partially overlaps with a VIN pin of the corresponding one of the first to fourth IPM units; a top surface pad of the GND electrical connector vertically and partially overlaps with a GND pin of the corresponding one of the first to fourth IPM units; and the column of input capacitors is arranged on an input side or an output side of the input positive electrical connector.

Preferably, wherein the plurality of electrical connectors further comprise signal electrical connectors; and the signal electrical connectors are adjacent with the signal pin columns of the corresponding part of the first to fourth IPM units.

Preferably, wherein voltages at two ends of the first winding, the second winding, the third winding and the fourth winding are sequentially staggered by 90 degrees.

Preferably, wherein the inductor is formed by following manufacturing steps:
step 1, preparing a metal plate, the thickness of the metal plate being far less than the length and width of the metal plate;
step 2, stamping the metal plate to form a first winding plate, wherein the first winding plate comprises four windings and four connecting tabs; the four connecting tabs are respectively arranged between two adjacent windings; the two adjacent windings are connected through corresponding connecting tab; then the first winding plate is subjected to electroplating treatment;
step 3, bending a first end of a winding upwards, and bending a second end of the same winding downwards;
step 4, assembling and fixing a part of the magnetic core and a winding assembly in the step 3, and then fixing and electrically connecting the winding assembly and the bottom plate assembly;
step 5, removing the four connecting tabs to form a semi-finished product, wherein the removing mode can be laser sintering, scribing machine or machining;
step 6, assembling and fixing the semi-finished product formed in the step 5 and other parts of the magnetic core to form the inductor.

Compared with the prior art, the application has the following beneficial effects:
(1) The application provides a VRM adopting a four-phase anti-coupling inductor technology. By applying a four-phase anti-coupling inductor technology, the VRM not only has rapid transient performance, but also has high conversion efficiency.
(2) By providing the structure and the manufacturing method of the four-phase anti-coupling inductor, the manufacturing difficulty of the four-phase anti-coupling inductor can be reduced.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic circuit diagram of a VRM using a four-phase coupling inductor technology;

FIG. 2A is a schematic structural diagram of Embodiment 1 of a VRM using a four-phase coupling inductor technology;

FIG. 2B is an exploded schematic diagram of Embodiment 1;

FIG. 2C is a schematic exploded view of an integrated inductor in Embodiment 1;

FIG. 2D is a schematic layout diagram of a top surface device according to Embodiment 1;

FIG. 2E is a schematic top view of a VRM integrated inductor in Embodiment 1;

FIG. 2F is a schematic structural diagram of another embodiment of an integrated inductor according to Embodiment 1;

FIG. 2G is an exploded schematic diagram of another embodiment of an integrated inductor according to Embodiment 1;

FIG. 3A is a schematic structural diagram of an embodiment of an inductor according to Embodiment 2;

FIG. 3B is an exploded schematic diagram of one embodiment of an inductor in Embodiment 2;

FIG. 3C is a schematic structural diagram of another embodiment of an inductor according to Embodiment 2;

FIG. 3D is a schematic exploded view of another embodiment of an inductor according to Embodiment 2;

FIG. 4A is a schematic structural diagram of an inductor in Embodiment 3;

FIG. 4B is a schematic exploded view of an inductor in Embodiment 3;

FIG. 5A is a schematic structural diagram of Embodiment 4 of a VRM using a four-phase anti-coupling inductor technology;

FIG. 5B is an exploded view of Embodiment 4 of VRM;

FIG. 5C is a schematic exploded view of the integrated inductor in Embodiment 4;

FIG. 6A is a schematic structural diagram of Embodiment 5 of a VRM using a four-phase anti-coupling inductor technology;

FIG. 6B is an exploded schematic diagram of Embodiment 5;

FIG. 6C is a schematic exploded view of the integrated inductor in Embodiment 5.

FIG. 6D is a top view of the integrated inductor in Embodiment 5.

FIG. 7A to FIG. 7E-5 are the first embodiments of a winding assembly and an inductor;

FIGS. 8A-8 E are the second embodiments of a winding assembly and an inductor; and

FIG. 9A to FIG. 9D are the third embodiments of a winding assembly and an inductor.

### DESCRIPTION OF THE EMBODIMENTS

One of the cores of the present application is to provide a VRM which enables the VRM not only to have fast transient performance but also high conversion efficiency by employing a four-phase anti-coupling inductance technique. According to the structure and the manufacturing method of the four-phase anti-coupling inductor, the manufacturing difficulty of the four-phase anti-coupling inductor can be reduced.

The technical solutions in the embodiments of the present disclosure will be clearly and completely described below with reference to the accompanying drawings in the embodiments of the present disclosure. All other embodiments obtained by a person of ordinary skill in the art based on the embodiments of the present application without creative efforts shall fall within the protection scope of the present application.

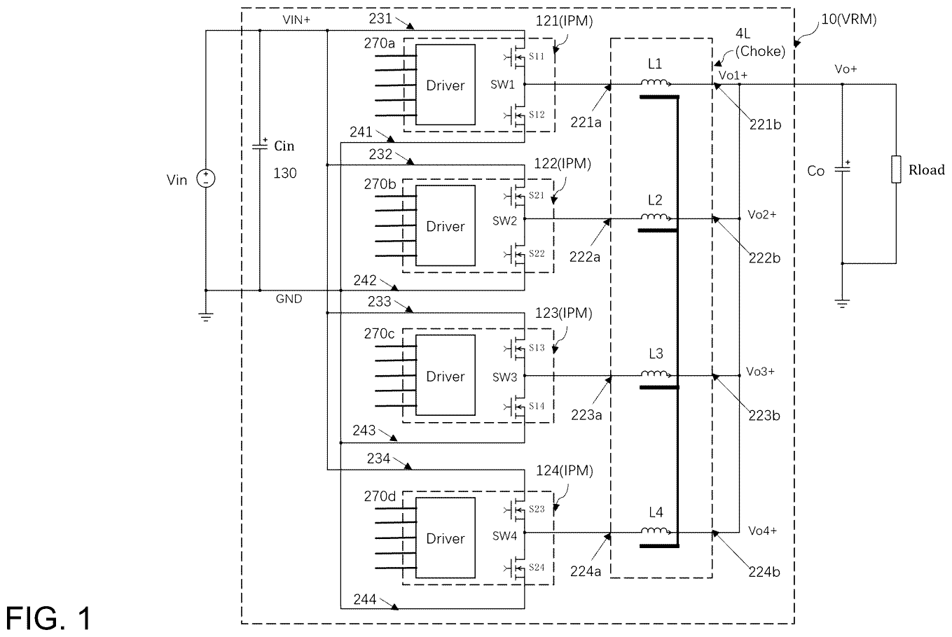

FIG. 1 is a schematic circuit diagram of a VRM (short referred to as four-phase anti-coupling VRM or VRM) adopting a four-phase anti-coupling inductor technology; as shown in FIG. 1, the VRM 10 comprises four IPM units 121/122/123/124, a four-phase anti-coupling inductor 4L, an input capacitor 130, four input positive connectors 231/232/233/234, four GND electrical connectors 241/242/243/244 and four groups of signal electrical connectors 270a/270b/270c/270d. Each IPM unit comprises an upper switch and a lower switch, wherein the upper switch and the lower switch are electrically connected in series to form a switch bridge arm, and one end of each switch bridge arm (ie the DRAIN end of the upper switch) is electrically connected with the input positive terminal Vin+ of the VRM through an input positive connector; the other end of each switch bridge arm (ie the source end of the lower switch) is electrically connected with the grounding end GND of the VRM through a GND electrical connector. The four-phase anti-coupling inductor 4L comprises four phases inductors, namely L1, L2, L 3 and L4, wherein the voltages at the two ends of the four phases inductors are sequentially staggered by 90 degrees, and the four-phase inductor winding meets the anti-coupling relationship in a winding mode. The midpoint of each switch bridge arm is a switch node SW, and specifically, the switch node SW1 or SW2 or SW3 or SW4 shown in FIG. 1 is electrically connected with the input end of a phase inductor respectively; and the output ends Vo1+/Vo2+/Vo3+/Vo4+ of the four-phase inductor form an output positive terminal Vo+ to be connected with a load to provide energy for the load. The input capacitor 130 is bridged at the two ends of the switch bridge arm and is used for bypassing the high-frequency switch ripple current generated by the switch bridge arm to ensure the stability of the input voltage. In the embodiment shown in FIG. 1, the input capacitor 130 is located on the input side of the four input positive connectors 231/232/233/234, that is, the left side of the four input positive connectors 231/232/233/234 and are closer to the input positive terminal of the VRM; in some embodiments, the input capacitor 130 can also be located on the output sides of the four input positive connectors 231/232/233/234, that is, the right side of the four input positive connectors 231/232/233/234 and are closer to the switch bridge arm. The signal electrical connector 270a/270b/270c/270d is used for transmission of a driving signal and a control signal required by the IPM unit.

### Embodiment 1

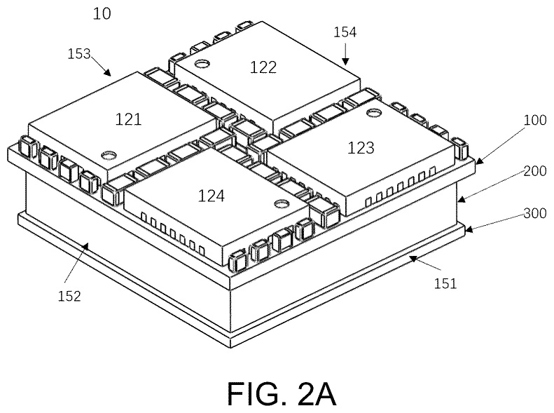

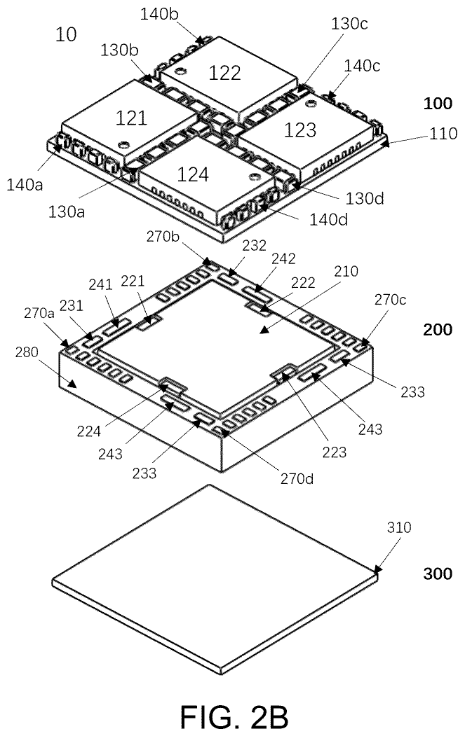

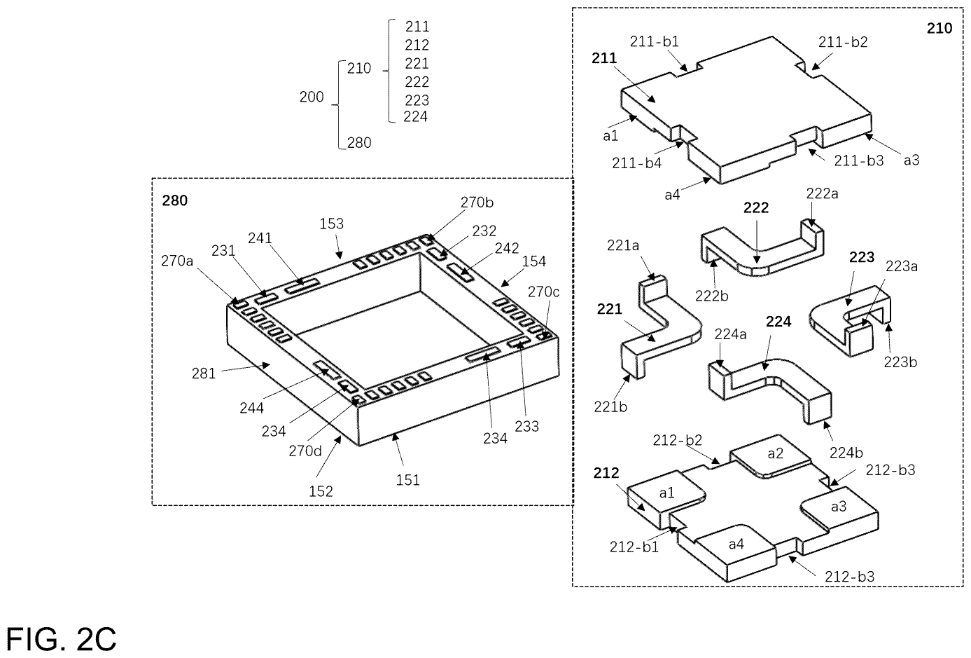

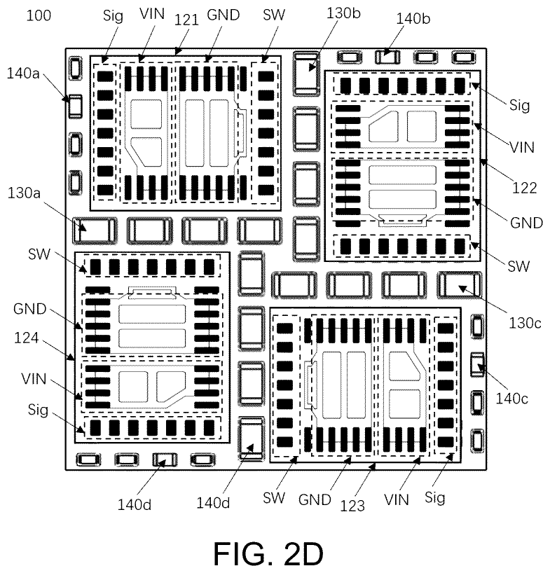

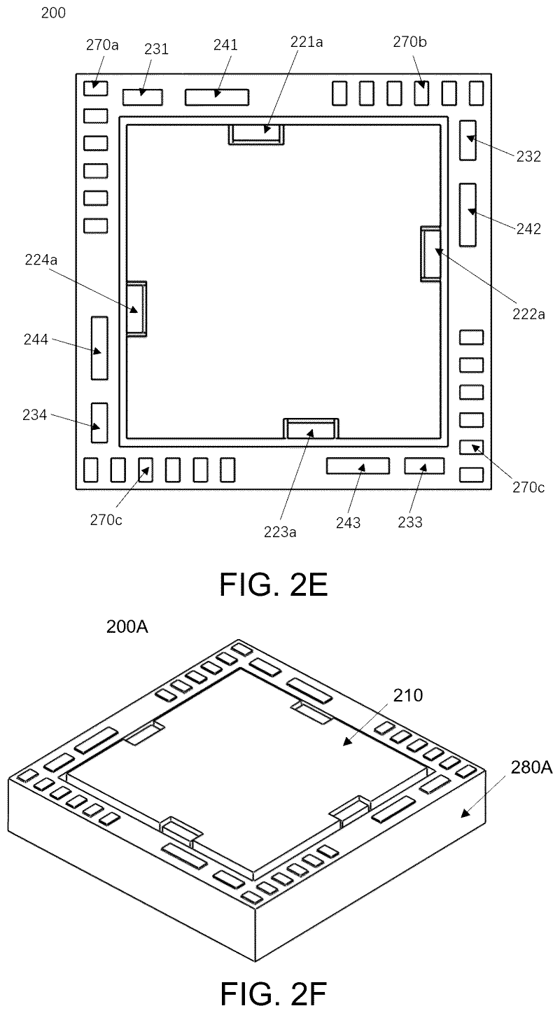

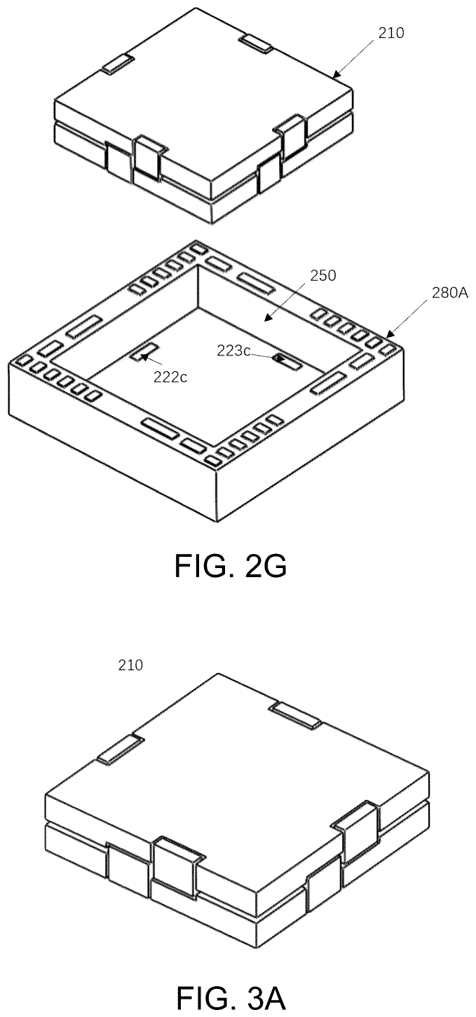

FIG. 2A is a schematic structural diagram of VRM 10, FIG. 2B is an exploded view of FIG. 2A, FIG. 2C is an exploded view of the integrated inductor 200 shown in FIG. 2B, and FIG. 2D is a schematic layout diagram of a top surface of the VRM shown in FIG. 2A. As shown in FIGS. 2A to 2D, the VRM comprises a top plate assembly 100, an integrated inductor 200 and a bottom plate assembly 300. The top plate assembly 100 comprises a top plate 110, a first IPM unit 121, a second IPM unit 122, a third IPM unit 123, a fourth IPM unit 124, an input capacitor 130 and other passive elements 140.

The VRM 10 further includes a first side surface 151, a second side surface 152, a third side surface 153, and a fourth side surface 154, wherein the first side surface 151 is opposite the third side surface 153, the second side surface 152 is opposite the fourth side surface 154, and the four side surfaces satisfy a clockwise rotational relationship. Four side surfaces of the VRM are defined to be the same as four side surfaces of the top plate assembly 100, and are also defined by four side surfaces of the integrated inductor 200 or four side surfaces of the bottom plate assembly 300, and are represented by a first side surface 151, a second side surface 152, a third side surface 153 and a fourth side surface 154.

The first IPM unit 121 is disposed adjacent to the second side surface 152 and the third side surface 153 of the top plate 110, and the signal pin column Sig of the first IPM unit 121 is parallel to and close to the second side surface 152 of the top plate 110; the second IPM unit 122 is arranged adjacent to the third side surface 153 and the fourth side surface 154 of the top plate 110, and the signal pin column Sig of the second IPM unit 122 is parallel to and close to the third side surface 153 of the top plate 110; the third IPM unit 123 is disposed adjacent to the fourth side surface 154 and the first side surface 151 of the top plate 110, and the signal pin column Sig of the third IPM unit 123 is parallel to and close to the fourth side surface 154 of the top plate 110; the fourth IPM unit 124 is disposed adjacent to the first side surface 151 and the second side surface 152, and the signal pin column Sig of the fourth IPM unit 124 is parallel to and close to the first side surface 151 of the top plate 110. Therefore, the first IPM unit 121, the second IPM unit 122, the third IPM unit 123 and the fourth IPM unit 124 are arranged on the top surface of the top plate 110, the signal pin column Sig of each IPM unit is sequentially arranged in the clockwise direction, and the approximate vertical relation is met between the signal pin columns of every two adjacent IPM. The input capacitor 130 is divided into four columns 130a/130b/130c/130d, each column of input capacitor is arranged between two adjacent IPM units, each column of input capacitor is arranged adjacent to the VIN pin and the GND pin of one IPM unit, and is perpendicular to the signal pin column of the IPM unit, so that a better filtering effect is obtained. The input capacitor column 130a is disposed between the first IPM unit 121 and the fourth IPM unit 124, and is bridged between the VIN pin and the GND pin of the first IPM unit 121, and is perpendicular to the signal pin column Sig of the first IPM unit 121; the input capacitor column 130b is arranged between the second IPM unit 122 and the first IPM unit 121, and is bridged between the VIN pin and the GND pin of the second IPM unit 122 and is perpendicular to the signal pin column Sig of the second IPM unit 122; the input capacitor column 130c is arranged between the third IPM unit 123 and the second IPM unit 122, and is bridged between the VIN pin and the GND pin of the third IPM unit 123, and is perpendicular to the signal pin column Sig of the third IPM unit 123; the input capacitor column 130d is arranged between the fourth IPM unit 124 and the third IPM unit 123, and is bridged between the VIN pin and the GND pin of the fourth IPM unit 124 and is perpendicular to the signal pin column Sig of the fourth IPM unit 124. Other passive elements 140a are disposed between the second side surface 152 of the top plate 110 and the signal pin column Sig of the first IPM unit 121, and are directly connected to a portion of the signal pin column Sig of the first IPM unit 121; and the other passive elements 140b are arranged between the third side surface 153 of the top plate 110 and the signal pin column Sig of the second IPM unit 122, and are directly connected with a portion of the pins of the signal pin column Sig of the second IPM unit 122; the other passive elements 140c are arranged between the fourth side surface 154 of the top plate 110 and the signal pin column Sig of the third IPM unit 123, and are directly connected with a portion of the pins of the signal pin column Sig of the third IPM unit 123; and the other passive elements 140d are arranged between the first side surface 151 of the top plate 110 and the signal pin column Sig of the fourth IPM unit 124, and are directly connected with a portion of the pins of the signal pin column Sig of the fourth IPM unit 124.

The integrated inductor 200 includes an inductor 210 and a frame 280; the inductor 210 is an independent inductor, the inductor 210 comprises a magnetic core and a winding, and the magnetic core comprises a first magnetic substrate 211, a second magnetic substrate 212 and four magnetic columns a1/a2/a3/a4; the winding comprises a first winding 221, a second winding 222, a third winding 223 and a fourth winding 224; the frame 280 comprises an input positive electrical connector 231/232/233/234, a GND electrical connector 241/242/243/244 and a signal electrical connector 270a/270b/270c/270d; and the four magnetic columns a1/a2/a3/a4 are arranged between the first magnetic substrate 211 and the second magnetic substrate 212. The four magnetic columns can be integrally sintered or laminated with the first magnetic substrate 211, and then are buckled together with the second magnetic substrate 212 to form a magnetic core. The four magnetic columns can also be integrally sintered or laminated with the second magnetic substrate 212, and then are buckled together with the first magnetic substrate 211 to form a magnetic core; or a part of each magnetic column in the four magnetic columns is integrally sintered or laminated with the first magnetic substrate 211, and the other part of each magnetic column and the second magnetic substrate 212 are integrally sintered or laminated; and after the two parts of each magnetic column are buckled in a one-to-one correspondence mode, a magnetic core is formed. Here, four side surfaces of the magnetic core are defined to be the same as four side surfaces of the VRM 10 or four side surfaces of the integrated inductor 200, and are also represented by a first side surface 151, a second side surface 152, a third side surface 153, and a fourth side surface 154. Each winding is wound around a corresponding magnetic column half circle of the inductor 210 in the horizontal direction, and the winding is bent towards the top surface of the magnetic core on one side surface of the magnetic core, and a first pin is formed on the top surface of the magnetic core; and the winding is bent towards the bottom surface of the magnetic core on the other side surface adjacent to the anticlockwise direction, and a second pin is formed on the bottom surface of the magnetic core. The winding of the first phase inductor L1 is also referred to as the first winding 221, is wound around the first magnetic column al half circle, is bent from the third side surface 153 of the magnetic core to the top surface of the magnetic core, and forms a first pin 221a on the top surface of the magnetic core; the first winding 221 is bent from the second side surface 152 of the magnetic core to the bottom surface of the magnetic core, the second pin 221b is formed on the bottom surface of the magnetic core. The winding of the second phase inductor L2 is also referred to as the second winding 222, is wound around the second magnetic column a2 half circle, the second winding 222 is bent towards the top surface of the magnetic core from the fourth side surface 154 of the magnetic core, and a first pin 222a is formed on the top surface of the magnetic core; the second winding 222 is bent from the third side surface 153 to the bottom surface of the magnetic core, a second pin 222b is formed on the bottom surface of the magnetic core. The winding of the third phase inductor L3 is also called as the third winding 223, is wound around the third magnetic column a3 half circle, the third winding 223 is bent towards the top surface from the first side surface 151 of the magnetic core, and a first pin 223a is formed on the top surface of the magnetic core; the third winding 223 is bent from the fourth side surface 154 to the bottom surface of the magnetic core, a second pin 223b is formed on the bottom surface of the magnetic core. The fourth phase inductor L4 is also called as the fourth winding 224, is wound around the fourth magnetic column a4 half circle, the fourth winding 224 is bent towards the top surface from the second side surface 152 of the magnetic core, and a first pin 224a is formed on the top surface of the magnetic core; the fourth winding 224 is bent from the first side surface 151 to the bottom surface of the magnetic core, a second pin 224b is formed on the bottom surface of the magnetic core. The four windings surround an air gap (not shown), and the air gap and the four windings are clamped between the first magnetic substrate 211 and the second magnetic substrate 212; the first magnetic substrate 211 is provided with notches 211-b1, 211-b2, 211-b3 and 211-b4, which are respectively used for accommodating the part of the winding 221/222/223/224 bending towards the top surface; the second magnetic substrate 212 is provided with notches 212-b1, 212-b2, 212-b3 and 212-b4, which are respectively used for accommodating the part of the winding 221/222/223/224 bending towards the bottom surface. A first pin arranged on the top surface of the integrated inductor 200 is electrically connected with a switch node SW pin of the corresponding IPM unit through the top plate 110; and a second pin arranged on the bottom surface of the integrated inductor 200 is electrically connected with an output positive terminal Vo+ pin of the VRM through the bottom plate assembly 300. When the VRM 10 works, the current flowing through each winding flows from the switch node SW1 or SW2 or SW3 or SW4 pin of the corresponding IPM unit to the output positive terminal Vo+ pin of the VRM. According to the winding arrangement mode shown in the embodiment, the first winding 221/the second winding 222/the third winding 223/the fourth winding 224 corresponding to the four-phase inductor L1/L2/L3/L4 are the same in the direct-current magnetic flux direction generated on the magnetic column, and the direct-current magnetic flux on the four magnetic columns can be closed through the air gap horizontally surrounded by the four windings, so that the four-phase inductor works in an anti-coupling state. In the application, each winding is led to the output positive terminal Vo+ pin of the VRM from the switch node SW pin corresponding to the IPM unit, and the winding is wound around the magnetic column clockwise; in some embodiments, each winding is led to the output positive terminal Vo+ pin of the VRM from the switch node SW pin corresponding to the IPM unit, and the winding can also be carried out around the magnetic column anticlockwise.

FIG. 2D is a top perspective view of FIG. 2A, and FIG. 2E is a top view of the integrated inductor 200 in FIG. 2B. As shown in FIG. 2D and FIG. 2E, a switch node SW pin of each IPM unit is disposed adjacent to a first pin of the corresponding and electrical connecting winding, and each of the switch node SW pins of each IPM unit vertically overlaps with a portion of the first pin 221a/222a/223a/224a disposed on the top surface of the integrated inductor (for example, the projection of the SW1 pin of the first IPM unit 121 at the top surface of the integrated inductor at least partially overlaps with the first pin 221a, and the following parts are vertically overlapped so as to be defined), so that the input end of each winding is directly vertically connected to the switch node SW pin of the IPM unit, thereby reducing the efficiency loss caused by the current flowing through the transverse part of the top plate 110, and facilitating the improvement of the efficiency of the VRM. a first pin 221a of the first winding 221 is vertically connected to a switch node SW1 pin of the first IPM unit nearby; a first pin 222a of the second winding 222 is vertically connected to a switch node SW2 pin of the second IPM unit nearby; a first pin 223a of the third winding 223 is vertically connected to a switch node SW3 pin of the third IPM unit nearby; and a first pin 224a of the fourth winding 224 is vertically connected to a switch node SW4 pin of the fourth IPM unit nearby. The position relationship between the four switch node SW pins and the first pin of the corresponding and electrical connecting winding is the same.

The input positive connector 231 and the GND electrical connector 241 are sequentially arranged on the frame 280 and close to the third side surface 153, and are respectively vertically partially overlapped with the VIN pin and the GND pin of the first IPM unit; the input positive electrical connector 232 and the GND electrical connector 242 are sequentially arranged on the frame 280 and are close to the fourth side surface 154, and the input positive electrical connector 232 and the GND electrical connector 242 are vertically partially overlapped with the VIN pin and the GND pin of the second IPM unit respectively; the input positive electrical connector 233 and the GND electrical connector 243 are sequentially arranged on the frame 280 and are close to the first side surface 151 and vertically partially overlapped with the VIN pin and the GND pin of the third IPM unit respectively; and the input positive electrical connector 234 and the GND electrical connector 244 are sequentially arranged on the frame 280 and close to the second side surface 152, and are vertically partially overlapped with the VIN pin and the GND pin of the fourth IPM unit respectively. Here, each connector includes a top surface pad disposed on a top surface of the frame 280 and a bottom surface pad disposed on a bottom surface of the frame 280. And the projections of the VIN pin and the GND pin of each IPM unit on the top surface of the frame 280 are at least partially overlapped with the top surface bonding pads correspondingly and electrically connected to the frame 280. According to the application, the input positive connector 231 and the GND electrical connector are vertically and nearby connected with the VIN pin and the GND pin of the corresponding IPM unit, so that the efficiency loss caused by the current flowing through the transverse part of the top plate 110 is reduced, and the conversion efficiency of the VRM is improved. On the frame 280, the first signal electrical connector 270a is disposed proximate to the second side surface 152 and disposed adjacent to the signal pin of the first IPM unit; the second signal electrical connector 270b is arranged close to the third side surface 153 and is arranged adjacent to the signal pin position of the second IPM unit; the third signal electrical connector 270c is arranged close to the fourth side surface 154 and is adjacent to the signal pin position of the third IPM unit; and the fourth signal electrical connector 270d is arranged close to the first side surface 151 and is adjacent to the signal pin of the fourth IPM unit. The signal electrical connector and the signal pin of the corresponding IPM unit are vertically arranged nearby and electrically connected, so that the length of the signal transmission path is effectively shortened, the interference coupled to the signal transmission path is reduced, and the reliability of the VRM is ensured. The inductor 210 and the frame 280 are welded together with the top plate assembly 100 and the bottom plate assembly 300 in a welding manner, so that the inductor 210 and the frame 280 are assembled together, and an integrated inductor 200 is formed.

FIG. 2F is a schematic structural diagram of another embodiment of an integrated inductor, and FIG. 2G is an exploded view of FIG. 2F. As shown in FIG. 2F and FIG. 2G, the integrated assembly 200A is further integrated by the integrated inductor 200 and the bottom plate assembly 300, the integrated inductor 200 comprises an inductor 210 and a frame 280A, an inductor groove 250 is formed in the middle of the top surface of the frame 280A, and is used for accommodating the inductor 210. A connector is arranged on the bottom surface of the frame 280A, and serves as an output positive Vo+ pin of the VRM. The VRM is directly fixed and electrically connected with the external system board through the connector. Winding pads 221c (not shown), 222c, 223c and 224c (not shown) are arranged at the bottom of the inductor groove 250, are respectively welded or electrically connected with the second pins 221b/222b/223b/224b of the inductor 210, and are electrically connected with the corresponding connectors through internal wiring arranged in the frame 280A. The input positive electrical connector, the GND electrical connector and the signal electrical connector are arranged in the frame 280A, and the GND electrical connector and the signal electrical connector are electrically connected with the corresponding connectors through internal wiring arranged in the frame. The input positive electrical connector, the GND electrical connector and the signal electrical connector each comprise a top surface bonding pad, and the top surface bonding pads are arranged on the top surface of the frame and are fixed and electrically connected with the top plate assembly. The inductor 210 shown in the embodiment is an independent inductor.

In the embodiment, the frame 280 and the bottom plate 310 shown in FIG. 2B are integrated in a complete frame, and the frame can be a printed circuit board, but is not limited thereto. According to the structure, the number of internal welding spots of the VRM can be reduced, and the reliability of the module is effectively improved. The structure of the integrated assembly 200A shown in the embodiment can be suitable for application occasions of independent inductors, that is, the inductor winding is independent of the structure of the frame.

### Embodiment 2

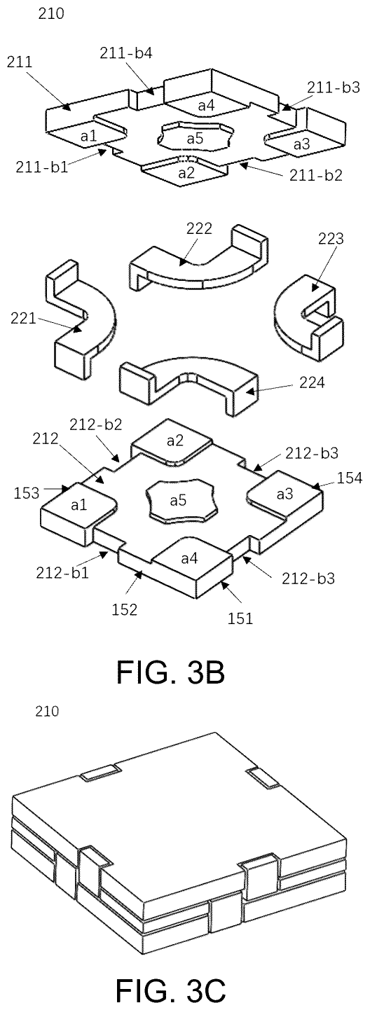

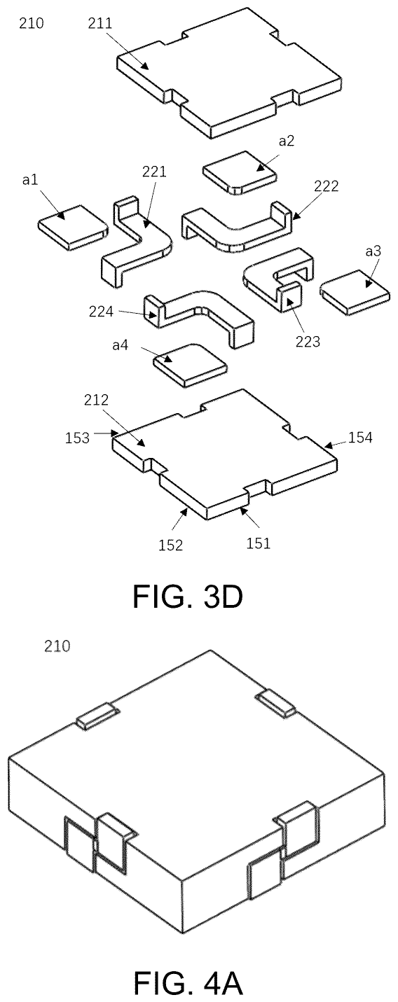

The difference between the embodiment and the first embodiment is that the inductor 210 is different from the first embodiment; the structure diagram of one embodiment of the inductor 210 is shown in FIG. 3A, and FIG. 3B is the exploded view of FIG. 3A.

In the embodiment, a fifth magnetic column a5 is further arranged in the middle of the four magnetic columns a1/a2/a3/a4 and magnetic core 210 adopts two symmetrical parts, that is, the first magnetic substrate 211 is integrally formed with half of the five magnetic columns, and the second magnetic substrate 212 and the other half of the five magnetic columns are integrally formed. The fifth magnetic column a5 is used for adjusting the magnitude of the leakage inductance, can meet different application requirements, and broadens the application range of the VRM. Compared with FIG. 2C in Embodiment 1 and FIG. 3D in Embodiment 2, the fifth magnetic column surrounded by the four windings replaces an air gap surrounded by the four windings; and the structure has the advantages that the equivalent steady-state inductance of each phase of inductor is increased, and the conversion efficiency of the VRM is improved.

FIG. 3C is a schematic structural diagram of another embodiment of the inductor 210, and FIG. 3D is an exploded view of the inductor 210 shown in FIG. 3C. As shown in FIG. 3C and FIG. 3D, the magnetic core also comprises a first magnetic substrate 211, a second magnetic substrate 212 and four magnetic columns a1/a2/a3/a4. In the embodiment, the four magnetic columns are separated from the first magnetic substrate 211 and the second magnetic substrate 212 and exist independently. Different from FIG. 3A and FIG. 2C, an air gap length is arranged on each magnetic column, and the air gap length is changed into the sum of the lengths of the two air gaps; under the condition that the total length of the air gap is not changed, the length of a single air gap is half of the original length, so that the winding loss caused by magnetic flux diffusion at the edge of the air gap is reduced, and the conversion efficiency of the VRM is further improved.

### Embodiment 3

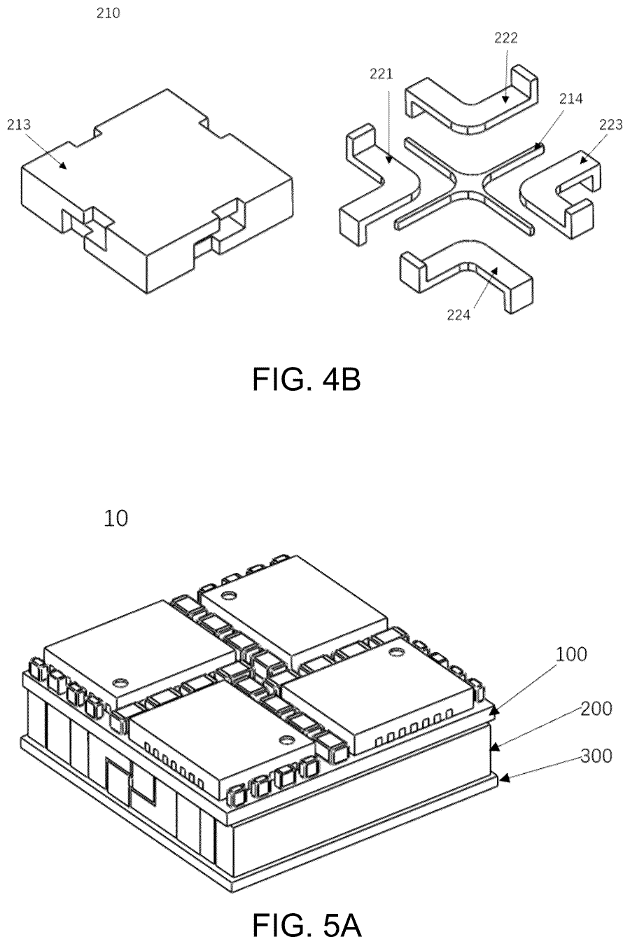

The difference between the embodiment shown in the embodiment and the first and second embodiment is the structure of the magnetic core. The schematic diagram of the structure of the inductor 210 is shown in FIG. 4A, and FIG. 4B is an exploded view of FIG. 4A. In the embodiment, the inductor 210 is integrally pressed and formed. The inductor 210 includes a first magnetic core 213, a second magnetic core 214, and four windings 221/222/223/224. The magnetic material of the first magnetic core 213 may be iron powder (Fe), iron-silicon-aluminum (L—Si—Al) powder, Fe—Si powder, Fe—Ni powder, nano-crystalline powder, amorphous powder, or the like, or mixtures thereof; and the material of the second magnetic core 214 is a non-magnetic material, an insulating material or a magnetic material with the magnetic conductivity lower than or equal to that of the first magnetic core 213. The magnetic powder core has the advantages that the magnetic powder core has good saturation characteristics and relatively good space utilization rate, and the conversion efficiency and the power density of the VRM can be improved.

### Embodiment 4

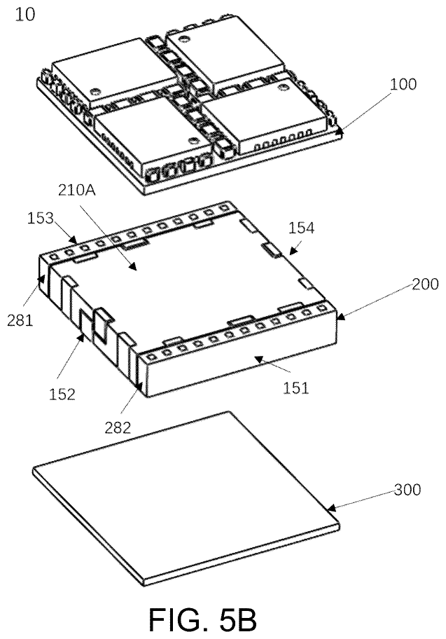

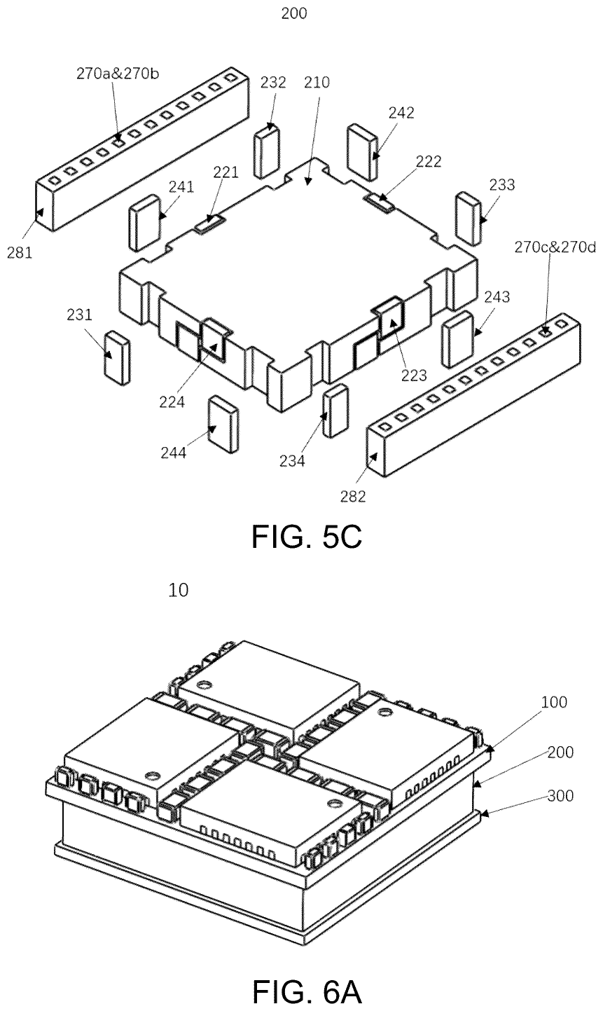

FIG. 5A is a schematic structural diagram of a VRM shown in this embodiment, and FIG. 5B is an exploded view of FIG. 5A. As shown in FIG. 5A and FIG. 5B, the VRM comprises a top plate assembly 100, the integrated inductor 200 and the bottom plate assembly 300. The structural layout of the top plate assembly 100 and the bottom plate assembly 300 are the same as those of the first embodiment, and the structure and layout of the integrated inductor 200 are different from that shown in Embodiment 1. FIG. 5C is an exploded view of the integrated inductor 200 in FIG. 5B. In the embodiment, the integrated inductor 200 comprises an inductor 210A, a vertical plate 281 and a vertical plate 282, wherein the inductor 210 comprises an input positive electrical connector 231/232/233/234, a GND electrical connector 241/242/243/244, and the magnetic core and the four windings 221/222/223/224. The inductor 210 can be integrally pressed and formed by an input positive electrical connector 231/232/233/234, a GND electrical connector 241/242/243/244, a magnetic core and four windings 221/222/223/224; the four windings and the magnetic material can be integrally pressed together, and then the input positive electrical connector 231/232/233/234 and the GND electrical connector 241/242/243/244 are bonded to the side surface of the magnetic core. The input positive electrical connector 231 is arranged close to the second side surface 152 of the magnetic core and is close to one side of the third side surface 153 of the magnetic core; and the GND electrical connector 241 is arranged close to the third side surface 153 of the magnetic core and is close to one side of the second side surface 152 of the magnetic core. The input positive electrical connector 232 is arranged close to the third side surface 153 of the magnetic core and is close to one side of the fourth side surface 154 of the magnetic core; and the GND electrical connector 242 is arranged close to the fourth side surface 154 of the magnetic core and is close to one side of the third side surface 153 of the magnetic core. The input positive electrical connector 233 is arranged close to the fourth side surface 154 of the magnetic core and is close to one side of the first side surface 151 of the magnetic core; and the GND electrical connector 243 is arranged close to the first side surface 151 of the magnetic core and is close to one side of the fourth side surface 154 of the magnetic core. The input positive electrical connector 234 is arranged close to the first side surface 151 of the magnetic core and is close to one side of the second side surface 152 of the magnetic core; and the GND electrical connector 244 is arranged close to the second side surface 152 of the magnetic core and is close to one side of the first side surface 151 of the magnetic core.

The signal electrical connector 270a/270b is disposed on the vertical plate 281, and the signal electrical connector 270c/270d is disposed on the vertical plate 282. The vertical plate 281 is attached to a third side surface 153 of the inductor 210, and the vertical plate 282 is attached to a first side surface 151 of the inductor 210. That is, the vertical plates 281 and 282 are respectively arranged on two opposite sides of the inductor 210. In the embodiment, the arrangement positions of the input positive electrical connector, the GND electrical connector and the signal electrical connector are not limited, and the arrangement can be carried out according to actual requirements.

### Embodiment 5

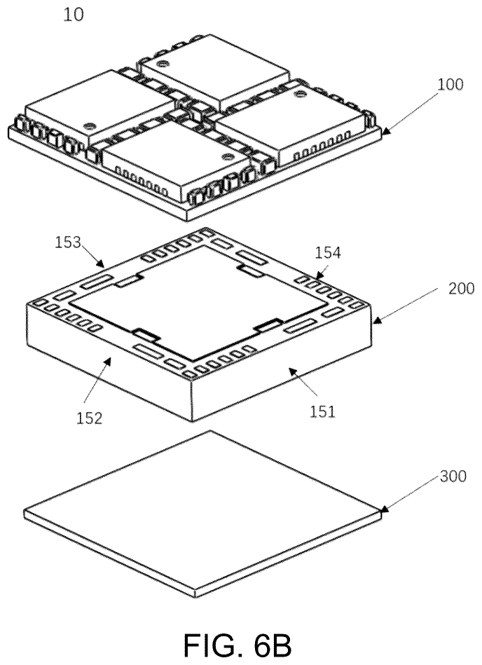

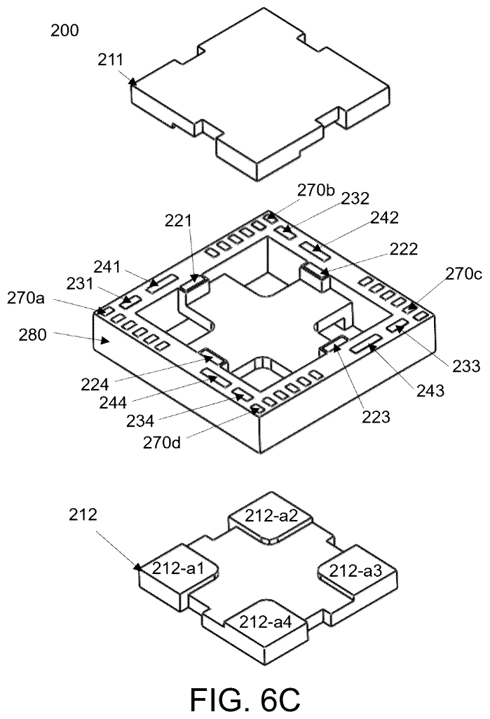

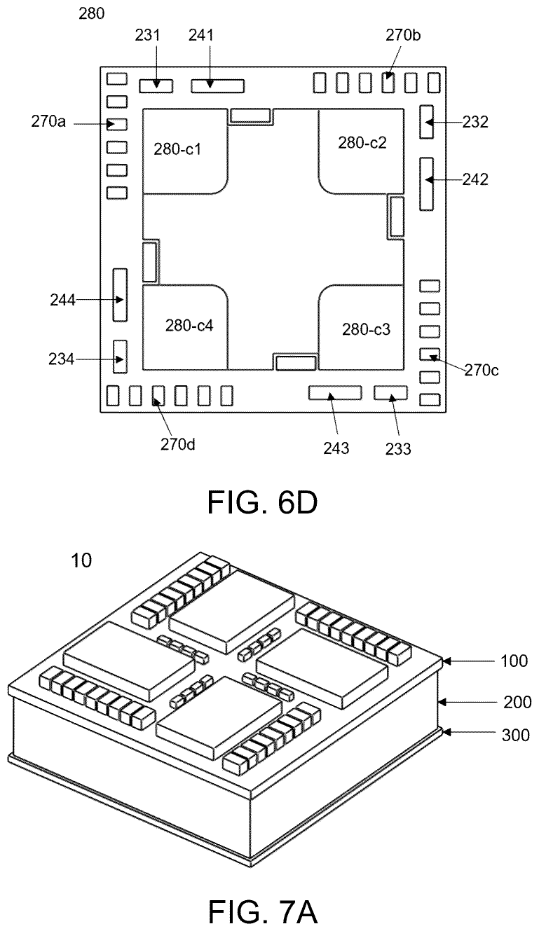

FIG. 6A is a schematic structural diagram of embodiment 5, FIG. 6B is an exploded view of FIG. 6A, FIG. 6C is an exploded view of the integrated inductor 200 shown in FIG. 6B, and FIG. 6D is a schematic top view of the integrated inductor 200. With reference to FIG. 6A to FIG. 6D, the embodiment has the same technical effect as the first embodiment. The VRM shown in the embodiment comprises a top plate assembly 100, an integrated inductor 200 and the bottom plate assembly 300. The structural layout of the top plate assembly 100 and the bottom plate assembly 300 are the same as those of the first embodiment, and the structure and layout of the integrated inductor 200 are different from that shown in Embodiment 1. According to the integrated inductor 200 shown in the embodiment, a winding, an input positive electrical connector, a GND electrical connector and a signal electrical connector are integrated in a printed circuit board through technologies such as a printed circuit board process and depth control milling, and then the first magnetic substrate 211 and the second magnetic substrate 212 are respectively buckled from the top surface and the bottom surface of the printed circuit board and arranged in a magnetic core groove formed by depth control milling, so that the structure and the function of the integrated inductor 210 shown in the application can be achieved.

In detail, the integrated inductor 200 includes a frame 280 and a magnetic core. The first winding 221, the second winding 222, the third winding 223 and the fourth winding 224 can be realized in the printed circuit board through wiring in the printed circuit board or embedded copper blocks, and the positive electrical connector, the GND electrical connector and the signal electrical connector are sequentially arranged on the periphery of the frame 280. The winding, the input positive electrical connector and a GND electrical connector can be led out to the top surface and the bottom surface of the frame 280 through drilling or groove digging and electroplating to form the top surface bonding pads and the bottom surface bonding pads; and the copper block can also be embedded, and a top surface bonding pad and a bottom surface bonding pad are formed on the surfaces of the copper blocks exposed out of the top surface and the bottom surface of the integrated inductor 200 through electroplating. The electrical connector, the top surface bonding pad and the bottom surface bonding pad can also be realized in a side wall electroplating mode. The signal electrical connectors 270a/270b/270c/270d can respectively form a top surface bonding pad and a bottom surface bonding pad on the top surface and the bottom surface of the frame 280 through a printed circuit board through-hole process or a side wall electroplating process, and are electrically connected in one-to-one correspondence. The frame 280 is provided with windows 280-c1, 280-c2, 280-c3 and 280-c4 for accommodating the four magnetic columns a1/a2/a3/a4 on the magnetic second substrate 212.

In the embodiment, the winding, the input positive electrical connector, the GND electrical connector and the signal electrical connector are integrated on the frame 280, the assembling process of the VRM inductor is simplified, the flatness of the top surface bonding pads and the flatness of the bottom surface bonding pads are improved, and the assembling reliability of the integrated inductor, the top plate assembly and the bottom plate assembly is further improved.

### Embodiment 6

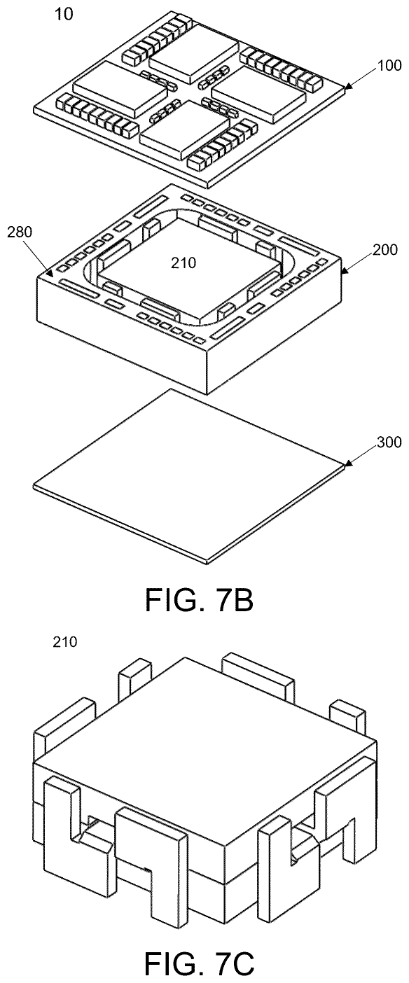

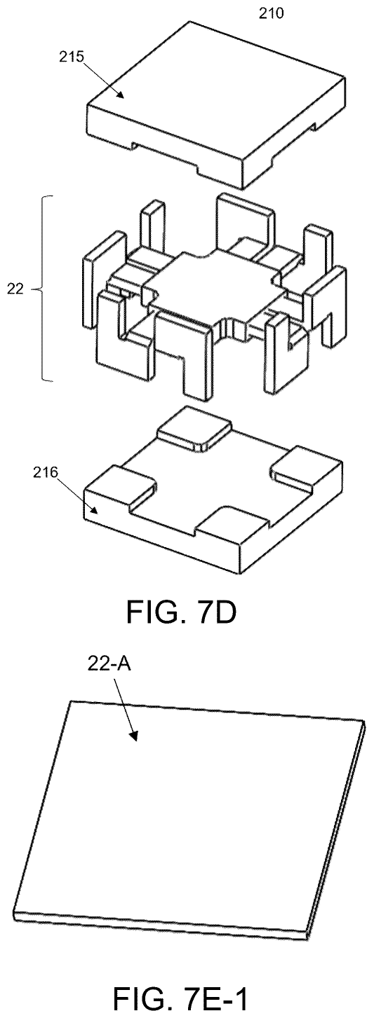

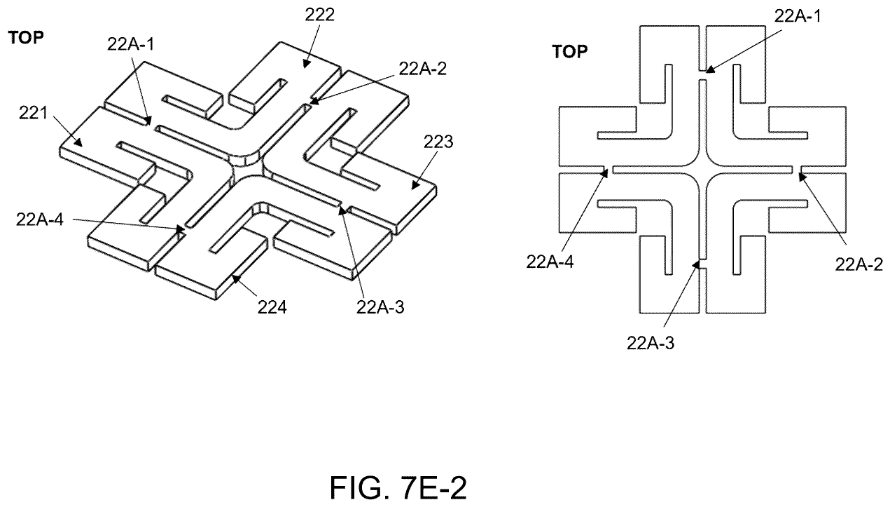

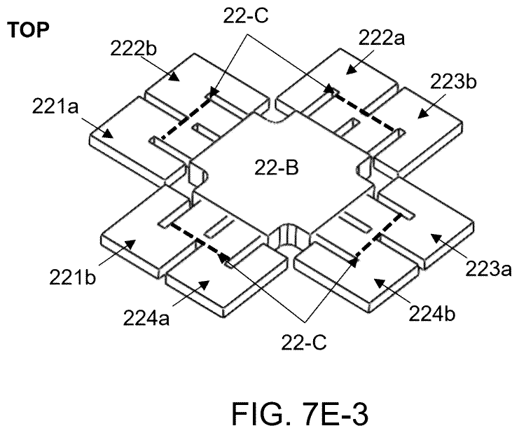

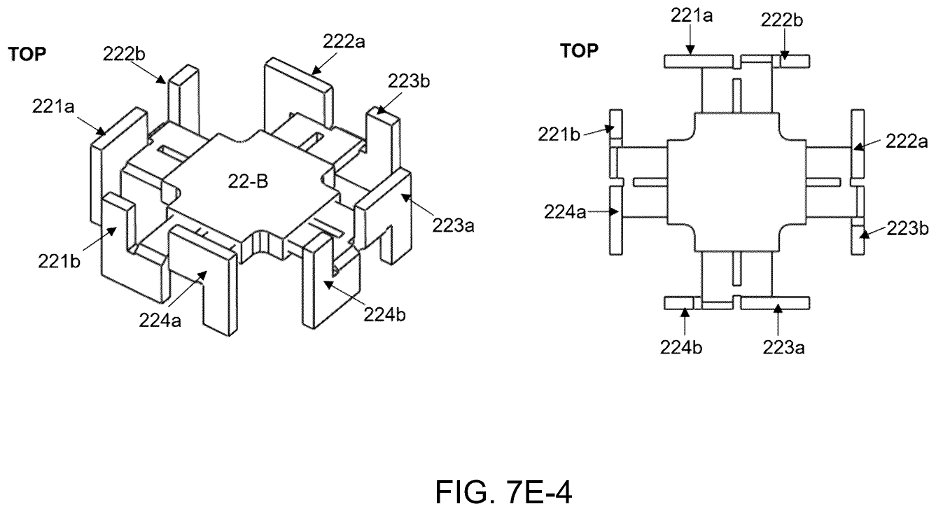

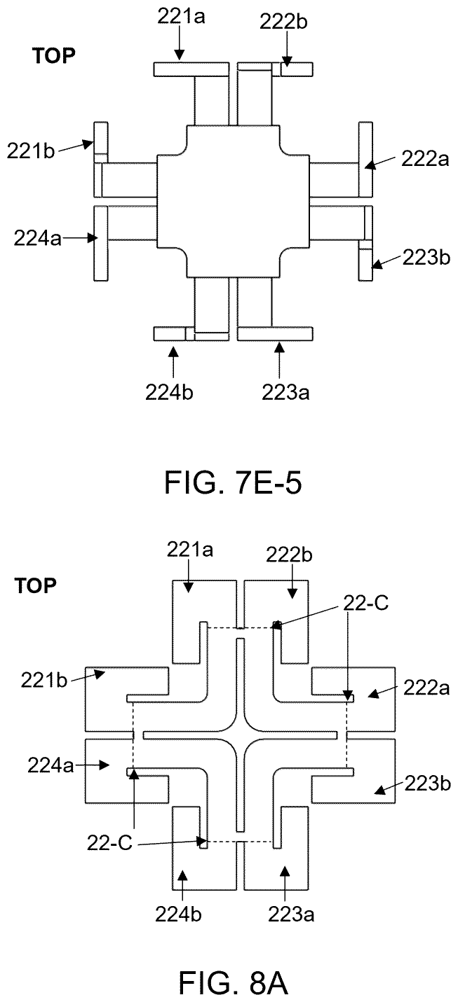

FIG. 7A is a schematic structural diagram of another VRM using a four-phase anti-coupling technology according to Embodiment 6, and FIG. 7B is an exploded view of FIG. 7A. As shown in FIG. 7A and FIG. 7B, the VRM shown in Embodiment 6 comprises a top plate assembly 100, an integrated inductor 200 and a bottom plate assembly 300. The integrated inductor 200 comprises an inductor 210 and a frame 280. The embodiment has the same technical effect as the embodiment shown in FIG. 2A. The main difference between the two embodiments is that the structure and the implementation process of the inductor 210 in the integrated inductor 200 are different.

Specifically, FIG. 7C is a schematic structural diagram of an inductor 210, and FIG. 7D is an exploded view of FIG. 7C. As shown in FIG. 7C and FIG. 7D, the inductor 210 comprises a first magnetic core 215, a second magnetic core 216 and a winding assembly 22. Each winding is in a special-shaped “H” shape, that is, both ends of each winding respectively extend upwards and downwards, so as to achieve stable connection between the inductor and the top plate assembly/the bottom plate assembly in the VRM.

The core of the present embodiment is an embodiment of the winding assembly 22 and the inductor 210. As shown in FIG. 7E-1 to FIG. 7E-5, the detailed steps are as follows:
Step 1, preparing a metal plate for manufacturing a winding as shown in FIG. 7E-1, wherein the metal plate has a certain length, width and thickness; in general, the thickness is far smaller than the length and the width; and the metal material is optimal by copper.
Step 2, stamping; stamping the metal plate shown in FIG. 7E-1 into the first winding plate shown in FIG. 7E-2, wherein the left image is a 3D schematic diagram, and the right image is a top view schematic diagram; the first winding plate comprises a winding 221/222/223/224, and the winding 221 is connected to the winding 222 by means of a connecting tab 22A-1; the winding 222 is connected to the winding 223 by means of a connecting tab 22A-2; the winding 223 and the winding 224 are connected by means of a connecting tab 22A-3; and the winding 224 and the winding 221 are connected by means of a connecting tab 22A-4. The stamped first winding plate is subjected to electroplating treatment, so that the welding position of the formed winding assembly is ensured to have weldability.
Step 3, plastic packaging or injection molding; as shown in FIG. 7E-3, the first winding plate completed in the step 2 is subjected to plastic packaging or plastic injection to form a fixing body 22-B; the fixing body 22-B is located between the four connecting tabs 22A-1/22A-2/22A-3/22A-4, and the four materials connecting position are exposed out of the fixing body 22-B.
Step 4, bending; bending according to the bending position 22-C shown by the dotted line in FIG. 7E-3; bending the first end of the same winding upwards, wherein the second end of the same winding is bent downwards; for example, the first end 221a of the winding 221 is bent upwards, and the second end 221b is bent downwards. The first end of one winding and the second end of the other winding are adjacent to the same connecting tab; for example, the first end 221a of the winding 221 and the second end 222b of the winding 222 are adjacent to the same connecting tab 22a-1, the first end 221a of the winding 221 is bent upwards, and the second end 222b of the winding 222 is bent downwards. As shown in FIG. 7E-4, each winding after bending is of a special-shaped “H” type. In the bending process, the pin connected with the top assembly and the pin connected with the bottom assembly are leveled, so that the flatness of the inductor pins is ensured to meet the requirement.
Step 5, separating; removing the four connecting tabs of the bent winding assembly, wherein the removing method can be in a laser sintering, scribing machine or machining mode and the like; and then the pin flatness requirement of the four-phase VRM can be met.

The winding assembly 22, the first magnetic core 215 and the second magnetic core 216 are combined by glue to realize the inductor 210 shown in FIG. 7C.

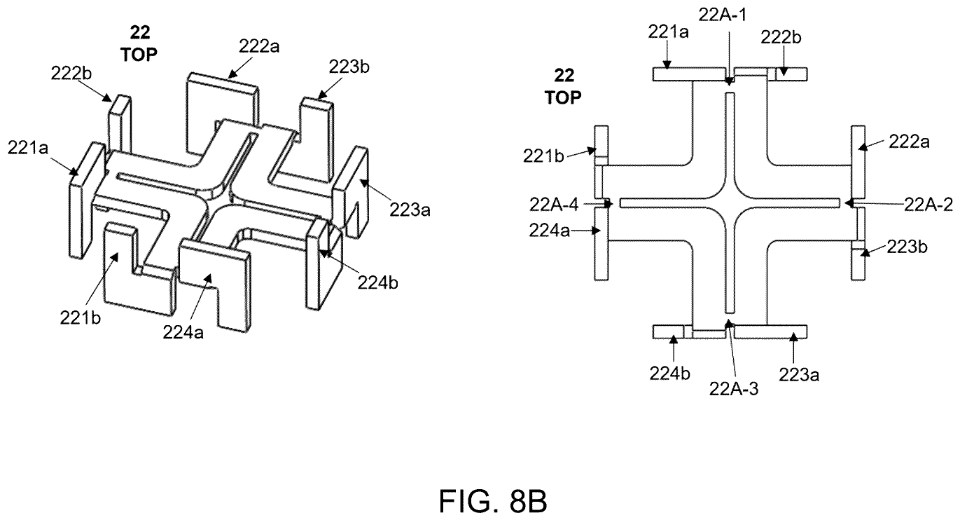

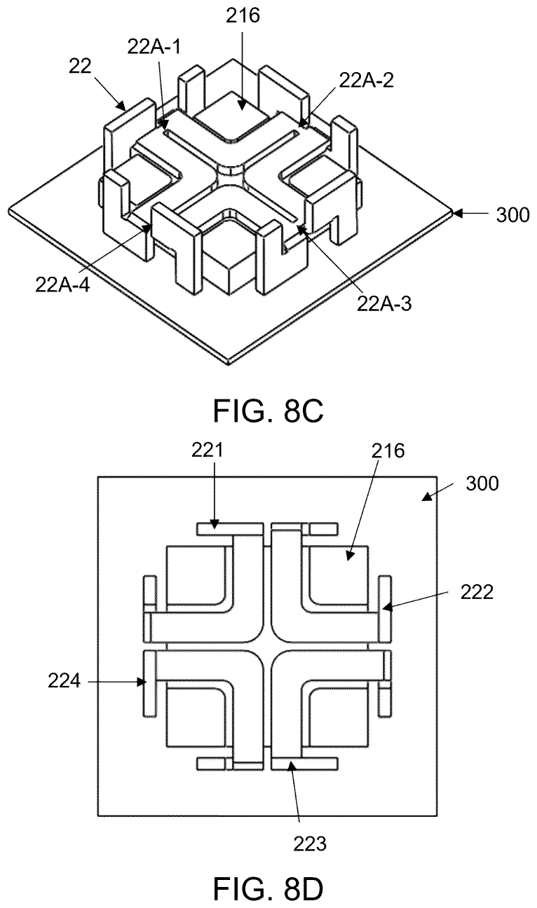

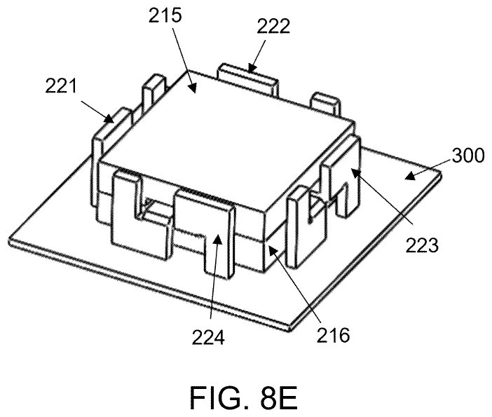

The embodiment also discloses a winding assembly 22 and the inductor 210 of an embodiment II. As shown in FIGS. 8A-8E, the first step and the second step are the same as the first step and the second step in the first embodiment;
Step 3, bending; bending the first winding plate shown in FIG. 8A according to the bending position 22-C shown by the dotted line; and the bending mode is the same as that in the first embodiment. A special-shaped “H” winding as shown in FIG. 8B is formed after bending, and the winding assembly 22 in the step further comprises a connecting tab, for example, a connecting tab 22A-1 between the windings 221 and 222, a connecting tab 22A-2 between the windings 222 and 223, a connecting tab 22A-3 between the windings 223 and 224, and a connecting tab 22A-4 between the windings 224 and 221.
Step 4, assembling and welding for the first time; as shown in FIG. 8C, assembling the second magnetic core 216 and the winding assembly in the step 3 together by using glue; and then welding the winding assembly with the second magnetic core 216 and the bottom plate 300 together. Due to the fact that the four windings are physically connected together before separation, the flatness of the pins of the winding assembly can meet the requirement. Optionally, the frame 280 may also be welded in this step.
Step 5,separating; as shown in FIG. 8D, removing the connecting tabs in the semi-finished product completed in the step 4 through laser sintering, scribing machines or machining and the like.
Step 6, carrying out secondary assembling and welding; and as shown in FIG. 8E, assembling the semi-finished product in the step 5 and the first magnetic core 215 together.

The semi-finished product formed in the step 6 can be welded and fixed with the top plate. By means of the steps, the inductors are assembled together, and the assembly of the VRM is partially completed, so that the flatness requirement of the inductor pins is met, and the assembly process is simplified.

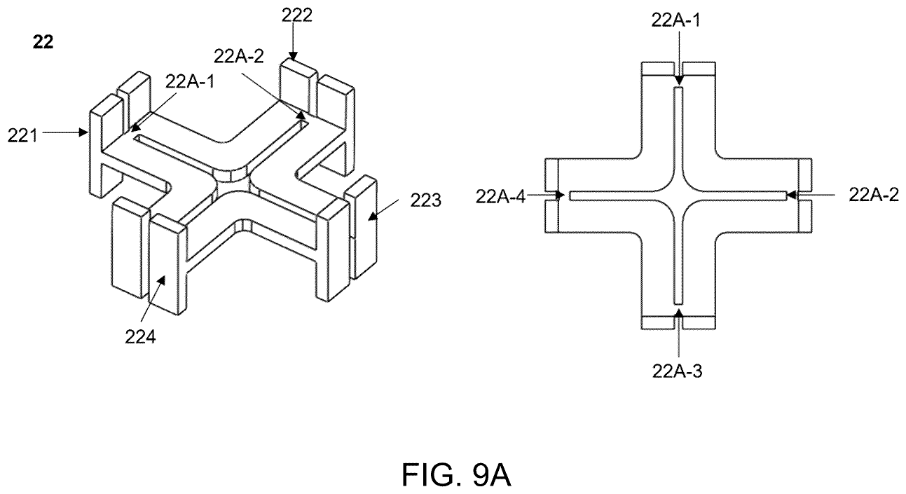

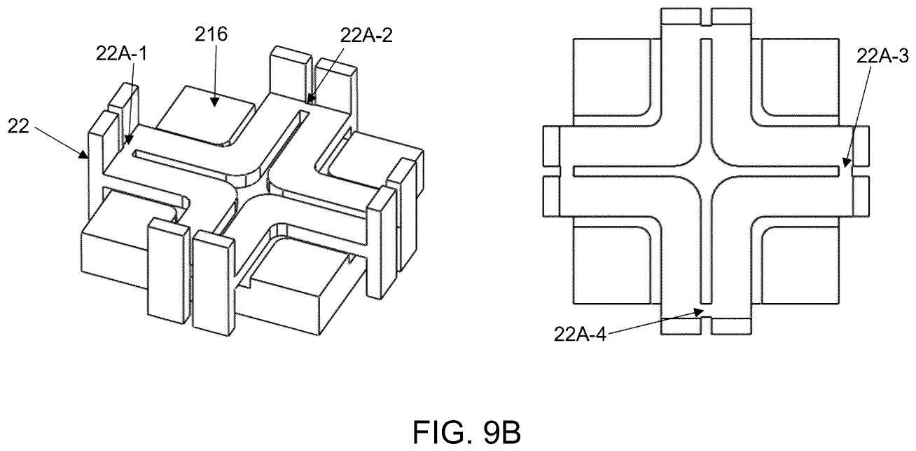

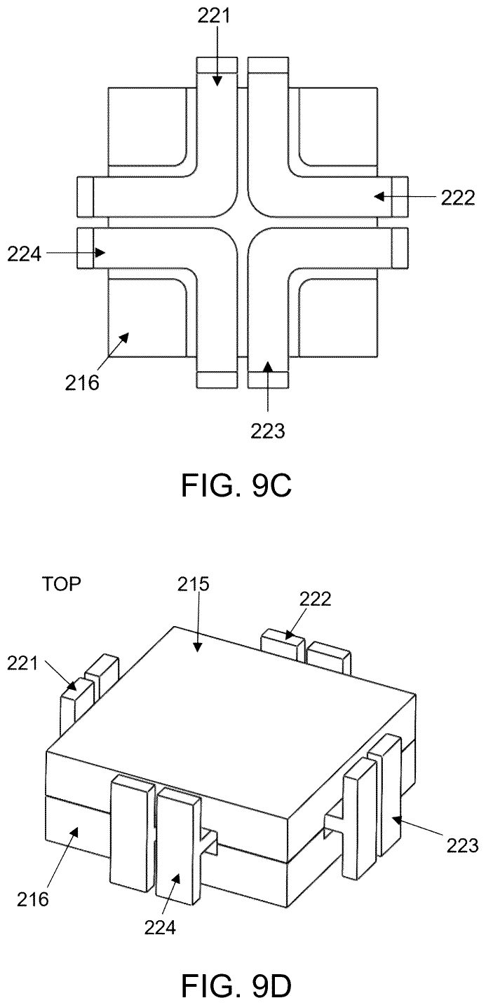

The embodiment also discloses an implementation method 3 of the winding assembly 22 and the inductor 210. As shown in FIG. 9A to FIG. 9D,
Step 1, forming; the metal powder is formed into the winding assembly shown in FIG. 9A through processes of high-pressure forging, die-casting, metal injection molding (MIM) and the like; the winding assembly in the step comprises a connecting tab 22A-1/22A-2/22A-3/22A-4, and each connecting tab respectively connect two of the four windings together; because the winding assembly in the step is molded at a time, the flatness of the pin in the winding assembly can meet the requirement. The metal powder in this step is optimal with copper powder.
Step 2, assembling; and as shown in FIG. 9B, combining the winding assembly obtained in the step 1 and the second magnetic core 216 with glue.
Step 3, separating; as shown in FIG. 9C, removing the connecting tabs in the semi-finished inductor obtained in the step 2 through laser sintering, scribing machines or machining and the like.
Step 4, performing secondary assembly; and as shown in FIG. 9D, assembling the semi-finished inductor obtained in the step 3 and the first magnetic core 215 together by using glue to obtain the inductor 210 with the flatness meeting the requirement.

According to the embodiment, the metal injection molding process is adopted, so that the inductor is simpler to manufacture.

In addition, the assembly of the second step in the third embodiment and the second assembly of the fourth step can also be applied to the second embodiment; and in the second embodiment, the first assembly and the welding in the step 4 and the second assembly and welding in the sixth step can also be applied to the third embodiment to obtain the same assembly technical effect.

The switch disclosed by the application can be used for realizing the functions of the switch disclosed by the application, such as a Si MOSFET, SiC MOSFET, GaN MOSFET or IGBT MOSFET.

The VRM module according to the embodiment can be an independent module or a part of the electronic device, and can meet the technical features and advantages disclosed by the application.

The “equal” or “same” or “equal to” disclosed by the application needs to consider the parameter distribution of engineering, and the error distribution is within +/−30%; and the included angle between the two line segments or the two straight lines is less than or equal to 45 degrees; the included angle between the two line segments or the two straight lines is within the range of [60, 120]; and the definition of the phase error phase also needs to consider the parameter distribution of the engineering, and the error distribution of the phase error degree is within +/−30%.

The embodiments in the specification are described in a progressive manner, each embodiment focuses on the difference from other embodiments, and the same similar parts between the embodiments can be referred to each other.

The above description of the disclosed embodiments enables a person skilled in the art to implement or use the present application. Various modifications to these embodiments will be readily apparent to those skilled in the art, and the generic principles defined herein may be implemented in other embodiments without departing from the spirit or scope of the application. Thus, the present application will not be limited to the embodiments shown herein but is to be accorded the widest scope consistent with the principles and novel features disclosed herein.

What is claimed is:

1. A integrated inductor comprises an inductor and a plurality of electrical connectors; the inductor comprises a magnetic core and a winding, and the winding comprises a first winding, a second winding, a third winding and a fourth winding; the integrated inductor is provided with four side surfaces, namely a first side surface, a second side surface, a third side surface and a fourth side surface, wherein the first side surface is opposite to the third side surface, and the second side surface is opposite to the fourth side surface;
the magnetic core comprises a first magnetic substrate, a second magnetic substrate and a magnetic column, the magnetic column is arranged between the first magnetic substrate and the second magnetic substrate, and the magnetic column comprises a first magnetic column, a second magnetic column, a third magnetic column and a fourth magnetic column;
each of the first to fourth windings is provided with a first pin and a second pin, the first pin of each of the first to fourth windings is arranged on a top surface of the integrated inductor, and the second pin of each of the first to fourth windings is arranged on a bottom surface of the integrated inductor; the first pins of the first to fourth windings are respectively arranged on the four side surfaces, and the four second pins are arranged on the four side surfaces respectively; the first pin and the second pin of each of the first to fourth windings are respectively arranged on two adjacent side surfaces;
the position of the first winding corresponds to the position of the first magnetic column, the position of the second winding corresponds to the position of the second magnetic column, the position of the third winding corresponds to the position of the third magnetic column, and the position of the fourth winding corresponds to the position of the fourth magnetic column; and each of the first to fourth windings is wound around the corresponding one of the first to fourth magnetic columns;
the plurality of electrical connectors are arranged adjacent to the four side surfaces of the integrated inductor respectively, each electrical connector comprises a top surface bonding pad and a bottom surface bonding pad, the top surface bonding pad of each electrical connector is arranged on the top surface of the integrated inductor, and the bottom surface bonding pad of each electrical connector is arranged on the bottom surface of the integrated inductor;
the integrated inductor is fixed and electrically connected with a top plate assembly through one of the first pins and one of the top surface bonding pads, and the integrated inductor is fixed and electrically connected with a bottom plate assembly through one of the second pins and one the bottom surface bonding pads.

2. The integrated inductor of claim 1, wherein the plurality of electrical connectors comprise four sets of electrical connector assemblies and a frame; the four sets of electrical connector assemblies are arranged in the frame; the four sets of electrical connector assemblies are arranged adjacent to the first side surface, the second side surface, the third side surface and the fourth side surface respectively; and the top surface bonding pads and the bottom surface bonding pads of the plurality of electrical connectors are arranged on a top surface and a bottom surface of the frame respectively.

3. The integrated inductor of claim 2, wherein each set of electrical connector combinations further comprise signal electrical connector; and an input positive electrical connector, a GND electric connector and the signal electrical connector in each set of electrical connector combinations are sequentially arranged in a same direction.

4. The integrated inductor of claim 2, wherein each set of electrical connector combinations comprises an input positive electrical connector and a GND electrical connector; and the input positive electrical connector and the GND electrical connector in each set of electrical connector combinations are sequentially arranged in a same direction.

5. The integrated inductor of claim 1, wherein each of the first to fourth windings comprises a first end and a second end; the first end is a part of the each of the first to fourth windings which is bent towards a top surface of the magnetic core; the second end is a part of the each of the first to fourth windings which is bent towards a bottom surface of the magnetic core; and the first end and the second end in a same winding are arranged adjacent to the two adjacent side surfaces respectively.

6. The integrated inductor of claim 5, wherein the first magnetic substrate comprises four notches, each notch is arranged adjacent to one corresponding side surface, and the notch is used for containing the first end of the each of the first to fourth windings; the second magnetic substrate comprises four notches, each notch is arranged adjacent to one corresponding side surface, and the four notches are used for containing the second end of the each of the first to fourth windings.

7. The integrated inductor of claim 6, wherein the magnetic core is made of a magnetic material, and the winding and the magnetic material are integrally pressed to form the inductor.

8. The integrated inductor of claim 7, wherein an electrical connector assembly is bonded to a side surface of the inductor.

9. The integrated inductor of claim 6, wherein the magnetic core is made of a magnetic material, and an electrical connector combination, the winding and the magnetic material are integrally pressed to form the inductor.

10. The integrated inductor of claim 9, wherein the electrical connector combination comprises an input positive electrical connector and a GND electrical connector; the integrated inductor further comprises a signal electrical connector, and the signal electrical connector is provided within two vertical plates; and the two vertical plates are arranged adjacent to the two opposite side surfaces respectively.

11. The integrated inductor of claim 1, wherein air gaps or fifth magnetic columns are further arranged in the middle of the first to fourth magnetic columns.

12. The integrated inductor of claim 2, wherein the frame comprises an inductor groove, the inductor groove is formed in the middle of the top surface of the frame, and the inductor groove is used for arranging the inductor; and a connecting part is arranged on the bottom surface of the frame.

13. The integrated inductor of claim 12, wherein a winding bonding pad is arranged on a bottom surface of the inductor groove; the winding bonding pad is fixed to the second pin and is electrically connected with the second pin.

14. The integrated inductor of claim 13, wherein the winding bonding pad is electrically connected with the corresponding connecting part through an internal wiring of the frame; and the plurality of electrical connectors are electrically connected with the corresponding connecting parts through the internal wiring of the frame.

15. The integrated inductor of claim 2, wherein the frame is a printed circuit board, and the plurality of electrical connectors and the first to fourth windings are arranged in the printed circuit board; a magnetic core groove is formed in a top surface and a bottom surface of the printed circuit board through a depth-controlled milling process; the magnetic core groove is used for accommodating a magnetic substrate; and the first magnetic substrate and the second magnetic substrate are respectively buckled with the winding from the top surface and the bottom surface of the printed circuit board.

16. The integrated inductor of claim 15, wherein the first to fourth windings are realized through internal wiring of the printed circuit board, or are realized through embedded copper blocks in the printed circuit board.

17. The integrated inductor of claim 15, wherein the plurality of electrical connectors can be realized by combining a drilling or digging groove with an electroplating process, or the plurality of electrical connectors are realized by embedded copper blocks in the printed circuit board.

18. The integrated inductor of claim 17, wherein the plurality of electrical connectors are input positive electrical connectors and GND electrical connectors; the integrated inductor further comprises a signal electrical connector; and the signal electrical connector is realized through a through hole.

19. The integrated inductor of claim 2, wherein each of the first to fourth windings is in “H” shape; a first end of each of the first to fourth windings extends upwards and downwards, and a second end of each of the first to fourth windings extends upwards and downwards.

20. The integrated inductor of claim 19, wherein the inductor is formed by following manufacturing steps:
step 1, preparing a metal plate, the thickness of the metal plate being far less than the length and width of the metal plate;
step 2, stamping the metal plate to form a first winding plate, wherein the first winding plate comprises four windings and four connecting tabs; the four connecting tabs are respectively arranged between two adjacent windings; the two adjacent windings are connected through corresponding connecting tab; then the first winding plate is subjected to electroplating treatment;
step 3, forming a fixing body on the first winding plate through plastic packaging materials or plastic injection; the fixing body is arranged between the four connecting tabs, and the four connecting tabs are exposed out of the fixing body;
step 4, bending a first end of a winding upwards, and bending a second end of the same winding downwards;
step 5, removing the four connecting tabs to form a winding assembly, wherein the removing mode can be laser sintering, scribing machine or machining;
the winding assembly and the magnetic core formed in the step 5 are assembled and fixed to form the inductor.

21. The integrated inductor of claim 19, wherein the inductor is formed by following manufacturing steps:
step 1, directly forming metal powder into an “H”-shaped winding assembly through processes such as high-pressure forging, die-casting, or metal injection molding (MIM); the winding assembly comprises four windings and four connecting tabs; the four connecting tabs are respectively arranged between two adjacent windings; the two adjacent windings are connected through corresponding connecting tabs;
step 2, assembling and fixing the winding assembly obtained in step 1 and a part of the magnetic core;
step 3, removing the four connecting tabs to form a semi-finished product, wherein the removing mode can be laser sintering, scribing machine or machining;
step 4, assembling and fixing the semi-finished product formed in the step 3 and other parts of the magnetic core to form the inductor.

22. A four-phase anti-coupling VRM comprises a top plate assembly and the integrated inductor of claim 1, wherein each of the first to fourth windings is fixed and electrically connected with the top plate assembly through respective first pins; and the plurality of electrical connectors are fixed and electrically connected with the top plate assembly through respective top surface bonding pads.

23. The four-phase anti-coupling VRM of claim 22, wherein a connecting part is directly fixed and electrically connected with an external system board.

24. The four-phase anti-coupling VRM of claim 22 further comprises a bottom plate assembly, and the second pin and a bottom bonding pad are electrically connected to an outside through the bottom plate assembly.

25. The four-phase anti-coupling VRM of claim 22, wherein the top plate assembly comprises an IPM unit, the IPM unit comprises a first IPM unit, a second IPM unit, a third IPM unit and a fourth IPM unit, and each IPM unit comprises a switch node; the position of the first winding corresponds to the position of the first IPM unit, the position of the second winding corresponds to the position of the second IPM unit, the position of the third winding corresponds to the position of the third IPM unit, and the position of the fourth winding corresponds to the position of the fourth IPM unit; and the first pin of each of the first to fourth windings is vertically and partially overlapped and electrically connected with the switch node of the corresponding one of the first to fourth IPM units.

26. The four-phase anti-coupling VRM of claim 25 further comprises four columns of input capacitors, wherein each column of input capacitors is arranged between two adjacent IPM units respectively; the IPM unit further comprises a signal pin column, a VIN pin and a GND pin; each column of input capacitors is arranged adjacent to the VIN pin and the GND pin of one of the first to fourth IPM unit; and each column of input capacitors is perpendicular to the signal pin column of the corresponding one of the first to fourth IPM units.

27. The four-phase anti-coupling VRM of claim 26 further comprises four columns of passive elements, wherein each column of the passive elements is respectively arranged between one side surface of the top plate assembly and a signal pin column corresponding to the IPM unit.

28. The four-phase anti-coupling VRM of claim 26, wherein the plurality of electrical connectors comprise an input positive electrical connector and a GND electrical connector; a top surface pad of the input positive electrical connector vertically and partially overlaps with a VIN pin of the corresponding one of the first to fourth IPM units; a top surface pad of the GND electrical connector vertically and partially overlaps with a GND pin of the corresponding one of the first to fourth IPM units; and the column of input capacitors is arranged on an input side or an output side of the input positive electrical connector.

29. The four-phase anti-coupling VRM of claim 28, wherein the plurality of electrical connectors further comprise signal electrical connectors; and the signal electrical connectors are adjacent with the signal pin columns of the corresponding part of the first to fourth IPM units.

30. The four-phase anti-coupling VRM of claim 25, wherein voltages at two ends of the first winding, the second winding, the third winding and the fourth winding are sequentially staggered by 90 degrees.

31. The four-phase anti-coupling VRM of claim 24, wherein the inductor is formed by following manufacturing steps:
step 1, preparing a metal plate, the thickness of the metal plate being far less than the length and width of the metal plate;
step 2, stamping the metal plate to form a first winding plate, wherein the first winding plate comprises four windings and four connecting tabs; the four connecting tabs are respectively arranged between two adjacent windings; the two adjacent windings are connected through corresponding connecting tab; then the first winding plate is subjected to electroplating treatment;
step 3, bending a first end of a winding upwards, and bending a second end of the same winding downwards;
step 4, assembling and fixing a part of the magnetic core and a winding assembly in the step 3, and then fixing and electrically connecting the winding assembly and the bottom plate assembly;
step 5, removing the four connecting tabs to form a semi-finished product, wherein the removing mode can be laser sintering, scribing machine or machining;
step 6, assembling and fixing the semi-finished product formed in the step 5 and other parts of the magnetic core to form the inductor.
